(19) United States
(12) Patent Application Publication
(10) Pub. No.: US 2024/0406855 A1
(43) Pub. Date: Dec. 5, 2024

(54) TRANSMITTING DATA TO A WIRELESS COMMUNICATION DEVICE

(71) Applicant: Telefonaktiebolaget LM Ericsson (publ), Stockholm (SE)

(72) Inventor: Leif WILHELMSSON, Lund (SE)

(21) Appl. No.: 18/688,585

(22) PCT Filed: Sep. 6, 2021
(86) PCT No.: PCT/EP2021/074512

§ 371 Date: Mar. 1, 2024

(51) Int. Cl. H04W 48/18; H04L 5/00; H04W 72/0453; H04W 74/0816

(52) U.S. Cl. CPC H04W 48/18; H04L 5/0012; H04W 72/0453; H04W 74/0816

(57) ABSTRACT

Methods and apparatus are provided. In an example aspect, a method in a first wireless communication device of transmitting data to a second wireless communication device is provided. The method includes selecting a first channel access mechanism or a second channel access mechanism based on a property of the data, and transmitting the data to the second wireless communication device according to the selected channel access mechanism.

### TECHNICAL FIELD

Examples of the present disclosure relate to transmitting data to a wireless communication device, for example using a channel access mechanism that is selected based on a property of the data.

### BACKGROUND

In wireless communication systems, when transmitting data in unlicensed bands, e.g. the 2.4 GHz Industrial, Scientific and Medical (ISM) band and the 5 GHz band, some means of spectrum sharing mechanism is typically required unless the transmissions are limited to use a very low power. The two most commonly used spectrum sharing mechanisms are listen before talk (LBT), also referred to as carrier sense multiple access with collision avoidance (CSMA/CA), and frequency hopping (FH).

The working procedure of LBT is as follows. Before a transmission can be initiated, the transmitter listens on the channel to determine whether it is idle or if there is already another transmission ongoing. If the channel is found to be idle, the transmission can be initiated, whereas if the channel is found to be busy, the transmitter has to defer from transmission and essentially keep sensing the channel until it becomes idle. LBT is used by different flavors of IEEE 802.11, commonly referred to as Wi-Fi, operating in e.g. the 2.4 GHz ISM band as well as in the 5 GHz band. LBT is also employed by standards developed by 3GPP operating in the 5 GHz band, e.g. New Radio (NR).

If instead FH is used, the spectrum sharing is based on only using a specific part of the band for a relatively small fraction of the total time, leaving room for other transmissions. FH is the approach used by Bluetooth.

Whether to employ LBT or FH for a particular situation is not clear, but typically LBT is the preferred approach if the used channel bandwidth it relatively large, say 20 MHz or more. FH, on the other hand, is well suited for narrowband systems where the bandwidth is on the order of 1 or 2 MHz for example.

In each case, the maximum data rate that can be supported is closely related to the channel bandwidth. As a rough rule-of-thumb, the maximum data rate that can be supported grows linearly with the channel bandwidth. Therefore, when there is a need to support high data rates, such that a large channel bandwidth is needed, LBT is often the preferred channel access mechanism.

On the other hand, when the requirements on data rate (throughput) are more relaxed, but instead there are challenging delay constraints, a relatively small channel bandwidth and FH is often the channel access mechanism of choice.

### SUMMARY

There is currently no standard operating in unlicensed or license-exempt frequency bands (e.g. 2.4 GHZ, 5 GHz and 6 GHz frequency bands) that can support both high data rate and low latency in an efficient way.

One aspect of the present disclosure provides a method in a first wireless communication device of transmitting data to a second wireless communication device. The method comprises selecting a first channel access mechanism or a second channel access mechanism based on a property of the data, and transmitting the data to the second wireless communication device according to the selected channel access mechanism.

A further aspect of the present disclosure provides apparatus in a first wireless communication device for transmitting data to a second wireless communication device. The apparatus comprises a processor and a memory. The memory contains instructions executable by the processor such that the apparatus is operable to select a first channel access mechanism or a second channel access mechanism based on a property of the data, and transmit the data to the second wireless communication device according to the selected channel access mechanism.

An additional aspect of the present disclosure provides apparatus in a first wireless communication device for transmitting data to a second wireless communication device. The apparatus is configured to select a first channel access mechanism or a second channel access mechanism based on a property of the data, and transmit the data to the second wireless communication device according to the selected channel access mechanism.

### BRIEF DESCRIPTION OF THE DRAWINGS

For a better understanding of examples of the present disclosure, and to show more clearly how the examples may be carried into effect, reference will now be made, by way of example only, to the following drawings in which:

FIG. 1 is a flow chart of an example of a method in a first wireless communication device of transmitting data to a second wireless communication device;

FIG. 2 shows an example of a system supporting both Listen Before Talk (LBT) and non-LBT;

FIG. 3 shows an example of a situation where a device has two different channel access mechanisms available;

FIG. 4 shows an example of a situation where different channel access mechanisms are used in the different directions for communication between two devices; and

FIG. 5 is a schematic of an example of an apparatus in a first wireless communication device for transmitting data to a second wireless communication device.

### DETAILED DESCRIPTION

The following sets forth specific details, such as particular embodiments or examples for purposes of explanation and not limitation. It will be appreciated by one skilled in the art that other examples may be employed apart from these specific details. In some instances, detailed descriptions of well-known methods, nodes, interfaces, circuits, and devices are omitted so as not obscure the description with unnecessary detail. Those skilled in the art will appreciate that the functions described may be implemented in one or more nodes using hardware circuitry (e.g., analogue and/or discrete logic gates interconnected to perform a specialized function, ASICs, PLAs, etc.) and/or using software programs and data in conjunction with one or more digital microprocessors or general purpose computers. Nodes that communicate using the air interface also have suitable radio communications circuitry. Moreover, where appropriate the technology can additionally be considered to be embodied entirely within any form of computer-readable memory, such as solid-state memory, magnetic disk, or optical disk containing an appropriate set of computer instructions that would cause a processor to carry out the techniques described herein.

Hardware implementation may include or encompass, without limitation, digital signal processor (DSP) hardware, a reduced instruction set processor, hardware (e.g., digital or analogue) circuitry including but not limited to application specific integrated circuit(s) (ASIC) and/or field programmable gate array(s) (FPGA(s)), and (where appropriate) state machines capable of performing such functions.

One way to look at the two above-described channel access mechanisms (LBT and FH) is that when a high data rate is required, it is better to let different users share the channel resources in time, whereas when low delay is required, it is better to share the channel resources in frequency.

To a large extent this explains why Wi-Fi uses LBT whereas Bluetooth uses FH. The primary goal for Wi-Fi is to provide high data rates, with use cases like file download and file streaming. Bluetooth, on the other hand, is more concerned with voice and other delay sensitive applications like connecting computer peripherals.

To allow for a standard to support both high data rate applications as well as low latency applications, a flexible channel access mechanism is disclosed in example embodiments of this disclosure. Specifically, for example, the choice of channel access mechanism may be based on a property of the data to be transmitted, for example the channel bandwidth to be used (e.g. throughput requirement for the data) or on the application to be supported. As an example of the former case, Listen Before Talk (LBT) may be used when the channel bandwidth is larger than or equal to a bandwidth threshold. For smaller bandwidth, for example, the channel access mechanism may be based on Frequency Hopping (FH) or be based on using a sufficiently low duty cycle. In some examples, LBT may be used when the application or data is not considered to be time-critical, whereas channel access without using LBT is only adopted when the application or data has strict delay constraints.

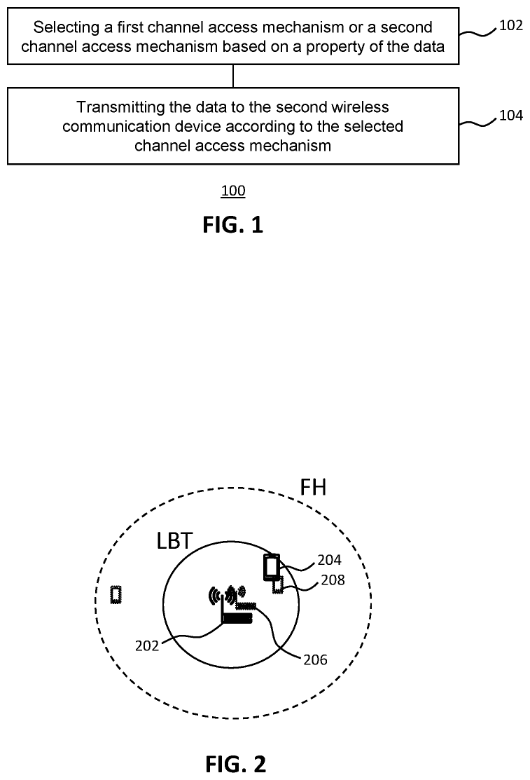

FIG. 1 is a flow chart of an example of a method 100 in a first wireless communication device of transmitting data to a second wireless communication device. For example, the first wireless communication device may in some examples be an Access Point (AP) and the second wireless communication device may be a Station (STA). In other examples, the first wireless communication device may be a STA and the second wireless communication device may be an AP. These terms are used to describe an AP device and non-AP device, and they may in some examples instead be referred to as an AP STA and a non-AP STA respectively. In still further examples, the devices may not be an AP or STA but instead some other type of device, e.g. a terminal device or User Equipment (UE), and a base station, for example in the case of 3GPP-based communication systems including those that operate in unlicensed spectrum, e.g. Long Term Evolution-License Assisted Access (LTE-LLA) or New Radio-Unlicensed (NR-U). Thus, in particular examples the first channel access mechanism and the second channel mechanism each access a respective channel in unlicensed spectrum.

The method 100 comprises, in step 102, selecting a first channel access mechanism or a second channel access mechanism based on a property of the data. In some examples, the first channel access mechanism is based on Listen Before Talk (LBT), and/or the second channel access mechanism is a mechanism that does not determine if the channel is free before transmitting. An example of the latter is Frequency Hopping (FH). The method 100 also comprises, in step 104, transmitting the data to the second wireless communication device according to the selected channel access mechanism. For example, transmitting the data to the second wireless communication device according to the first channel access mechanism comprises transmitting the data using a bandwidth of 20 MHz, 40 MHz, 80 MHZ, or 160 MHz, and transmitting the data to the second wireless communication device according to the second channel access mechanism comprises transmitting the data using a bandwidth of 1 MHZ, 2 MHz, or 4 MHz. These are merely examples and other bandwidths may be possible; generally, however, in some examples, transmitting the data in accordance with the first channel access mechanism may use a larger bandwidth than transmitting the data in accordance with the second channel access mechanism.

In some examples, the second channel access mechanism has a faster average time to access a communication channel than the first channel access mechanism. This may be the case for example where the first channel access mechanism uses LBT, and the second channel access mechanism does not check if the channel is free and/or uses FH. When using LBT, the channel must first be sensed before the channel can be accessed for transmission; if the channel is busy, then the device must back off and wait for the channel to become idle. A channel access mechanism that does not use LBT, e.g. based on FH, may transmit straight away without any delays associated with sensing a channel or backing off if it is busy. Therefore, the delay or latency in accessing the channel will be lower for the second channel access mechanism than the first channel access mechanism.

In some examples, the different channel access mechanisms may provide access to the same frequency band, e.g. a band in unlicensed spectrum such as the 2.4 GHz, 5 GHz or 6 GHz band. In other examples, however, the first channel access mechanism is associated with a communication channel in a first frequency band and the second channel access mechanism is associated with a communication channel in a second frequency band different to the first frequency band. For example, the first frequency band may comprise a 5 GHz or 6 GHz unlicensed band, and the second frequency band comprises a 2.4 GHz unlicensed frequency band.

In some examples, the property of the data comprises a latency condition for the data and/or a throughput condition for the data. Thus, for example, selecting the first channel access mechanism or the second channel access mechanism based on the property of the data may comprise any one or more of: selecting the first channel access mechanism when the latency condition comprises a high or relaxed latency constraint; selecting the second channel access mechanism when the latency condition comprises a low, strict or bounded latency constraint; selecting the first channel access mechanism when the throughput condition comprises a high throughput constraint; and/or selecting the second channel access mechanism when the throughput condition comprises a low throughput constraint. In some examples, a high latency comprises a latency that is higher than a latency threshold, and a low latency comprises a latency that is lower than the latency threshold. Additionally or alternatively, for example, a high throughput comprises a latency that is higher than a throughput threshold, and a low throughput comprises a latency that is lower than the throughput threshold.

In some examples, the property of the data comprises a latency condition for the data and/or throughput condition for the data. Thus, for example, selecting the first channel access mechanism or the second channel access mechanism based on the property of the data may comprise one or more of: selecting the first channel access mechanism when the latency condition comprises no latency constraint; selecting the second channel access mechanism when the latency condition comprises a latency constraint; selecting the first channel access mechanism when the throughput condition comprises a throughput constraint; and/or selecting the second channel access mechanism when the throughput condition comprises no throughput constraint.

In some examples, the property of the data comprises a type of an application associated with the data. Thus, for example, selecting the first channel access mechanism or the second channel access mechanism based on the property of the data may comprise one or both of: selecting the second channel access mechanism when the type of the application comprises a delay sensitive application and/or a low throughput application, or an application that does not have an associated throughput constraint; and selecting the first channel access mechanism when the type of the application comprises a type other than a delay sensitive application or a low throughput application, or an application that does not have an associated latency or delay constraint.

Thus, for example, data that has (or is associated with or generated by an application that has) a low latency constraint (e.g. below a particular latency threshold) may be transmitted according to the channel access mechanism that has a lower average access time or delay than the other channel access mechanism. On the other hand, for example, data that has no such latency constraint, or has a constraint that is above the threshold, or is data with a high throughput constraint (e.g. above a throughput threshold), may be transmitted according to the channel access mechanism that has a higher average access time or latency. This channel access mechanism may in some examples use a larger bandwidth and thus have a generally higher throughput.

In some examples, the first channel access mechanism uses Listen Before Talk (LBT) to access a wireless communication channel, and/or the second channel access mechanism uses Frequency Hopping (FH) to access a wireless communication channel. FH may in some examples have a lower latency or access time to access a communication channel than LBT, for example because it may not first sense whether the channel is busy before transmitting.

In some examples, the method is performed in accordance with a single or the same wireless communication technology or standard. For example, where Bluetooth and Wi-Fi are each a communication technology or standard that uses just one of FH or Wi-Fi respectively to access a communication channel, embodiments of this disclosure contemplate a single technology or standard that may use multiple channel access mechanisms, such as FH and LBT, in accordance with the method 100. Therefore, in some examples, the method 100 (and any device that implements such a method) may support both high data rate applications and low latency applications with the same standard. Since only one standard is needed, this may allow for better coexistence between different applications and by that enhanced spectrum utilization. Additionally or alternatively, for example, this may result in reduced cost and/or implementation complexity compared to using two or more standards.

In some examples, the method 100 may comprise receiving additional data from the second wireless communication device, wherein the additional data is received according to the selected channel access mechanism or the channel access mechanism other than the selected channel access mechanism. Thus for example received data and transmitted data may be considered independently, that is, received/transmitted in accordance with the same or different channel access mechanisms depending on the circumstances (e.g. the property of the transmitted or received data suggested above).

The method 100 may in some examples additionally comprise further selecting the first channel access mechanism or the second channel access mechanism based on a property of further data, and transmitting the further data to the second wireless communication device or another wireless communication device according to the further selected channel access mechanism. Thus, the further data may for example be transmitted with the same or a different channel access mechanism than earlier transmitted data depending on the circumstances (e.g. the property of the data/further data). For example, the method 100 may comprise further selecting the first channel access mechanism or the second channel access mechanism based on the property of further data comprises selecting the other of the selected first or second channel access mechanism, wherein the property of the data is different to the property of the further data. In some examples, the selected channel access mechanism comprises the second channel access mechanism and the further selected channel access mechanism comprises the first channel access mechanism, The method 100 may thus comprise transmitting the further data according to the first channel access mechanism after successful transmission of the data to the second wireless communication device, wherein successful transmission of the data comprises a transmission and zero or more retransmissions of the data to the second wireless communication device. In some examples, the selected channel access mechanism and the further channel access mechanism are the same channel access mechanism. Thus, for example, the first channel access mechanism is selected when a total throughput constraint for the data and the further data is above a total throughput threshold, and the second channel access mechanism is selected when the total throughput constraint for the data and the further data is above the total throughput threshold or there is no total throughput constraint for the data and the further data.

Particular examples will now be described for two specific channel access mechanisms, one using LBT and another not using LBT. The channel access mechanism not using LBT will in these examples be based on FH. Moreover, by means of illustration, the channel access mechanism will be based on LBT when the system intends to use a channel bandwidth of 20 MHz or more, e.g. 20, 40, 80, or 160 MHz. Conversely, the channel access mechanism will be based on FH when the channel bandwidth is less than 20 MHz. In these examples, it will be assumed that bandwidths of 1, 2, and 4 MHz are supported when the channel access mechanism is based on FH. These bandwidths and channel access mechanisms are provided merely to illustrate these particular examples and are not limiting.

A simple example deployment is illustrated in FIG. 2, which shows an example of a system supporting both Listen Before Talk (LBT) and non-LBT. In this figure, wideband channel access based on LBT is illustrated by a large access point (AP) 202 and large station (STA) 204, whereas narrowband channel access is illustrated by a small AP 206 and a small STA 208. The large AP 202 and small AP 206 devices are in some examples collocated, and are shown next to each other for clarity. In FIG. 2, the solid and dashed circles are shown to illustrate the coverage area when LBT and FH is used, respectively.

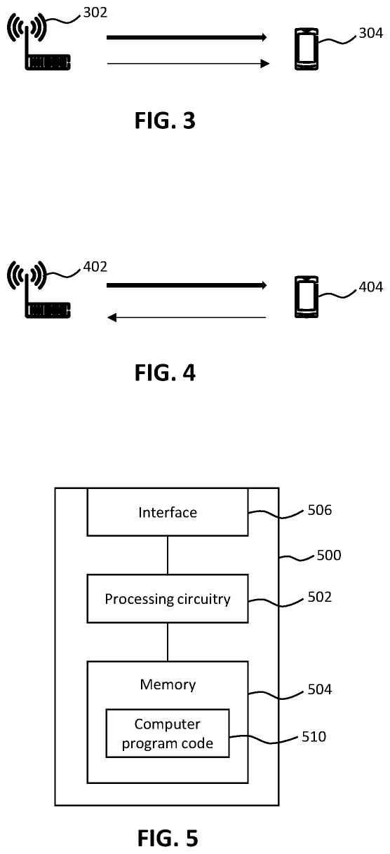

The situation is also illustrated in FIG. 3, which shows an example of transmissions between an AP and a STA. One of the devices 302 (the AP in this case) can use either LBT (thick arrow) or non-LBT (thin arrow) for transmitting data to the other device 304 (the STA in this case).

In some examples, different channel access mechanism may be selected in the opposite directions, as illustrated in FIG. 4, which shows an example of a situation where different channel access mechanisms are used in the different directions for communication between two devices. In this example, it may be that there is a file download from the AP 402, whereas there is a different application from the STA 404. It should be noted in this example that the arrows correspond to different data streams, and not the situation with one data stream and only corresponding ACK/NACK in the other direction.

In a single link scenario, to illustrate an example of selection of the channel access mechanism to use, first suppose that there are only two devices involved in the communication, e.g. one access point (AP) and one station (STA). This could for instance correspond to the AP and the STA within the solid circle in FIG. 2. Moreover, suppose that the transmission is from the AP to the STA and that the AP can select to either use a 20 MHz channel using LBT or a 1 MHz using FH.
1. In a first scenario, the application to be supported is video streaming. In this case it is determined that the average data rate needed is 5 Mb/s and that there are relaxed requirements on the delay/latency as the receiver will be able to buffer data. In this case, the AP selects to use LBT and a 20 MHz channel since this allows for much higher instantaneous data rate. Even if 5 Mb/s would be feasible to support also with a 1 MHz channel bandwidth, using the 20 MHz channel may in some examples allow both the transmitter and the receiver to be turned off for some periods when not transmitting/receiving and in this way save energy. Thus, in this case the channel access mechanism based on LBT is selected due to energy consumption and/or throughput consideration.
2. In a second scenario, the application is file download. This is a best effort application and it may be beneficial to download the file as quickly as possible. Therefore, in this case, the channel access mechanism based on LBT is selected.
3. In a third scenario, the application is gaming. In this case the data rate is not so high, but it may be a constraint that the latency/delay is less than 10 ms not to significantly impact the performance of the game. LBT gives very unpredictable delay, and in particular there is a high risk that the channel cannot be accessed within the required 10 ms. Consequently, the selected channel access mechanism is FH.
4. In a fourth scenario, there are two applications running in parallel, one file download and one gaming application. In this case the communication between the AP and the STA will make use of both LBT and FH. In this example, the transmitter will use FH for the gaming application and LBT for the download application. It can be noted that the channel access delay for FH is so small that it may also allow for retransmission of the packet if the first transmission fails. Thus, for example, by using FH with a fixed transmission interval, say every 5 ms, it is possible in some examples to use LBT transmission in between. In case the first FH transmission is successful, there would be almost 5 ms available for the LBT transmission (assuming the FH transmission is short), whereas if one or more retransmissions are needed or the FH transmission, there will be less time available for the LBT transmission. This may however be acceptable since it is a best effort application.
5. In a fifth scenario, where energy consumption is of major concern, the most energy efficient approach is selected. As suggested above, this may mean using the LBT based channel access when a large packet is to be sent as this then can be performed in a shorter time due to the higher bandwidth or throughput. However, in cases of small packets, the additional time required for performing LBT may not be justified. In this case, i.e., for small packet sizes, it may be preferable to use e.g. FH without LBT.

In some examples, several STAs may be associated with a single AP. In this situation, the selection of which channel access mechanism to use may have to take more parameters into account.

If the total data rate that needs to be supported is high, it may be so that LBT channel access is the only option to be used based on that it allows for higher aggregated throughput.

If there are strict delay constraints that need to be met, using FH may be the only option to be used. If it is the case for example that the aggregated throughput for the different links is too high, then the AP may need to limit the number of STAs that are supported.

In case the different STAs supported by the AP have different requirements when it comes to delay constraints, the AP may select to use LBT based channel access for the STAs having less strict requirements and using FH based channel access to the STAs having more strict requirements.

If the AP is able to support two concurrent links, one based on LBT channel access and one based on FH, the LBT may be done without taking the FH links into account. This may for example be the case when the LBT is used in the 5 GHz band or in the 6 GHz band, whereas FH is used for the links in the 2.4 GHz band.

If, on the other hand, both the links using LBT and FH are operating in the same frequency band concurrent operation may not be feasible in some examples. Therefore, either a link based on LBT or a link using FH may be used. In this example, priority may be given to the link using FH, since by assumption this is used for applications with more strict time, delay or latency requirements.

In some examples, LBT may be applied in one direction where a non-LBT based channel access mechanism may be used in the other direction (e.g. the two directions shown in FIG. 4).

In some examples, a device may support operation in more than one frequency band for at least one of the channel mechanisms. Therefore, in such examples, further optimization may be possible. Specifically, for example, the LBT based channel access mechanism and the non-LBT channel mechanism may be used in different bands to allow for concurrent operation, as discussed above. The choice of which frequency band to use for LBT based channel access mechanism and which band to use for the non-LBT based channel access mechanism may then be based on one or more of the following parameters in some examples:
The band having the largest available bandwidth is used for the links using LBT.
The interference situations in the available bands are considered, and the frequency band determined to have the least amount of interference is allocated to the system using FH as this link may be used for time-critical applications.
The interference situations in the available bands are considered, and it is determined whether the experienced interference is mainly due to links using LBT or links not using LBT, e.g. links using FH. The selection of bands is then done such that the same channel access mechanism is selected as the one used by the experienced interference. Specifically, if it is determined that the interference is mainly due to signals using LBT, the LBT based channel access is selected and vice versa. The reason for this is that the coexistence between different links may be improved if the same or similar coexistence mechanisms are used by all (or some) devices trying to access the channel.

FIG. 5 is a schematic of an example of an apparatus 500 in a first wireless communication device for transmitting data to a second wireless communication device. The apparatus 500 comprises processing circuitry 502 (e.g. one or more processors) and a memory 504 in communication with the processing circuitry 502. The memory 504 contains instructions, such as computer program code 510, executable by the processing circuitry 502. The apparatus 500 also comprises an interface 506 in communication with the processing circuitry 502. Although the interface 506, processing circuitry 502 and memory 504 are shown connected in series, these may alternatively be interconnected in any other way, for example via a bus.

In one embodiment, the memory 504 contains instructions executable by the processing circuitry 502 such that the apparatus 500 is operable/configured to select a first channel access mechanism or a second channel access mechanism based on a property of the data, and transmit the data to the second wireless communication device according to the selected channel access mechanism. In some examples, the apparatus 500 is operable/configured to carry out the method 100 described above with reference to FIG. 1.

It should be noted that the above-mentioned examples illustrate rather than limit the invention, and that those skilled in the art will be able to design many alternative examples without departing from the scope of the appended statements. The word “comprising” does not exclude the presence of elements or steps other than those listed in a claim, “a” or “an” does not exclude a plurality, and a single processor or other unit may fulfil the functions of several units recited in the statements below. Where the terms, “first”, “second” etc. are used they are to be understood merely as labels for the convenient identification of a particular feature. In particular, they are not to be interpreted as describing the first or the second feature of a plurality of such features (i.e. the first or second of such features to occur in time or space) unless explicitly stated otherwise. Steps in the methods disclosed herein may be carried out in any order unless expressly otherwise stated. Any reference signs in the statements shall not be construed so as to limit their scope.

1. A method in a first wireless communication device of transmitting data to a second wireless communication device, the method comprising:
selecting a first channel access mechanism or a second channel access mechanism based on a property of the data; and
transmitting the data to the second wireless communication device according to the selected channel access mechanism.

2. The method of claim 1, wherein:
the second channel access mechanism has a faster average time to access a communication channel than the first channel access mechanism.

3. The method of claim 1, wherein the first channel access mechanism is associated with a communication channel in a first frequency band and the second channel access mechanism is associated with a communication channel in a second frequency band different to the first frequency band.

4. The method of claim 3, wherein the first frequency band comprises a 5 GHz or 6 GHz unlicensed band, and the second frequency band comprises a 2.4 GHz unlicensed frequency band.

5. The method of claim 2, wherein the property of the data comprises one or both of a latency condition for the data and a throughput condition for the data, and selecting the first channel access mechanism or the second channel access mechanism based on the property of the data comprises one or more of:
selecting the first channel access mechanism when the latency condition comprises a high or relaxed latency constraint;
selecting the second channel access mechanism when the latency condition comprises a low, strict or bounded latency constraint;
selecting the first channel access mechanism when the throughput condition comprises a high throughput constraint; and
selecting the second channel access mechanism when the throughput condition comprises a low throughput constraint.

6. The method of claim 5, wherein one or both:
a high latency comprises a latency that is higher than a latency threshold, and a low latency comprises a latency that is lower than the latency threshold; and
a high throughput comprises a latency that is higher than a throughput threshold, and a low throughput comprises a latency that is lower than the throughput threshold.

7. The method of claim 2, wherein the property of the data comprises one or both of a latency condition for the data and a throughput condition for the data, and selecting the first channel access mechanism or the second channel access mechanism based on the property of the data comprises one or more of:
selecting the first channel access mechanism when the latency condition comprises no latency constraint;
selecting the second channel access mechanism when the latency condition comprises a latency constraint;
selecting the first channel access mechanism when the throughput condition comprises a throughput constraint; and
selecting the second channel access mechanism when the throughput condition comprises no throughput constraint.

8. The method of claim 2, wherein the property of the data comprises a type of an application associated with the data, and selecting the first channel access mechanism or the second channel access mechanism based on the property of the data comprises:
selecting the second channel access mechanism when the type of the application comprises one or both of a delay sensitive application and a low throughput application, or an application that does not have an associated throughput constraint; and
selecting the first channel access mechanism when the type of the application comprises a type other than a delay sensitive application or a low throughput application, or an application that does not have an associated latency or delay constraint.

9. The method of claim 1, wherein one or both:
the first channel access mechanism uses Listen Before Talk (LBT) to access a wireless communication channel; and
the second channel access mechanism uses Frequency Hopping (FH) to access a wireless communication channel.

10. The method of claim 1, wherein the method is performed in accordance with a single or the same wireless communication technology or standard.

11. The method of claim 1, wherein transmitting the data to the second wireless communication device according to the first channel access mechanism comprises transmitting the data using a bandwidth of 20 HMz, 40 MHz, 80 MHz or 160 MHz, and transmitting the data to the second wireless communication device according to the second channel access mechanism comprises transmitting the data using a bandwidth of 1 MHz, 2 MHz or 4 MHz.

12. The method of claim 1, comprising receiving additional data from the second wireless communication device, wherein the additional data is received according to the selected channel access mechanism or the channel access mechanism other than the selected channel access mechanism.

13. The method of claim 1, comprising:
further selecting the first channel access mechanism or the second channel access mechanism based on a property of further data; and
transmitting the further data to the second wireless communication device or another wireless communication device according to the further selected channel access mechanism.

14. The method of claim 13, wherein further selecting the first channel access mechanism or the second channel access mechanism based on the property of further data comprises selecting the other of the selected first or second channel access mechanism, wherein the property of the data is different to the property of the further data.

15. The method of claim 14, wherein the selected channel access mechanism comprises the second channel access mechanism and the further selected channel access mechanism comprises the first channel access mechanism, and the method comprises:
transmitting the further data according to the first channel access mechanism after successful transmission of the data to the second wireless communication device, wherein successful transmission of the data comprises a transmission and zero or more retransmissions of the data to the second wireless communication device.

16. The method of claim 15, wherein the selected channel access mechanism and the further channel access mechanism are the same channel access mechanism, and wherein:
the first channel access mechanism is selected when a total throughput constraint for the data and the further data is above a total throughput threshold; and
the second channel access mechanism is selected when the total throughput constraint for the data and the further data is above the total throughput threshold or there is no total throughput constraint for the data and the further data.

17. The method of claim 1, wherein the first channel access mechanism and the second channel mechanism each access a respective channel in unlicensed spectrum.

18. The method of claim 1, wherein:
the first wireless communication device comprises an access point (AP) and the second wireless communication device comprises a station (STA); or
the first wireless communication device comprises a station (STA) and the second wireless communication device comprises an access point (AP).

19. A computer storage medium storing a computer program comprising instructions which, when executed on at least one processor, cause the at least one processor to carry out a method of transmitting data, the method comprising:
selecting a first channel access mechanism or a second channel access mechanism based on a property of the data; and
transmitting the data from a first wireless communication device to a second wireless communication device according to the selected channel access mechanism.

20. (canceled)

21. (canceled)

22. An apparatus in a first wireless communication device for transmitting data to a second wireless communication device, the apparatus comprising a processor and a memory, the memory containing instructions executable by the processor such that the apparatus is operable to:
select a first channel access mechanism or a second channel access mechanism based on a property of the data; and
transmit the data to the second wireless communication device according to the selected channel access mechanism.

23. The apparatus of claim 22, wherein the second channel access mechanism has a faster average time to access a communication channel than the first channel access mechanism.

24. (canceled)

25. (canceled)
